(19) United States
(12) Patent Application Publication
(10) Pub. No.: US 2020/0048421 A1
(43) Pub. Date: Feb. 13, 2020

(54) CATION-EXCHANGE POLYMER AND METHODS OF PRODUCTION

(71) Applicant: BL Technologies, Inc., Minnetonka, MN (US)

(72) Inventors: Kai ZHANG, Singapore (SG); Li May GOH, Singapore (SG); Seng Yong GOH, Singapore (SG); John H. BARBER, Guelph (CA); Russell James MACDONALD, Burlington, MA (US); Yongchang ZHENG, Westborough, MA (US); Yonghong ZHAO, Singapore (SG)

(21) Appl. No.: 16/344,882

(22) PCT Filed: Nov. 1, 2016
(86) PCT No.: PCT/US2016/059926

§ 371 Date: Apr. 25, 2019

(51) Int. Cl. C08J 5/22; B01J 39/20; B01D 61/46; B01D 69/02; B01D 71/40

(52) U.S. Cl. CPC C08J 5/2243; B01J 39/20; B01D 61/46; B01D 69/02; C02F 1/4691; C08J 2333/26; C08J 2333/14; B01D 2325/42; B01D 71/40

(57) ABSTRACT

The present disclosure provides a method of producing a cation exchange polymer, the method includes polymerizing an anionic monomer in the presence of a polymerizable crosslinker having a cationic functional group. A sufficient amount of anionic monomer is used to provide both the anionic charges necessary for cation exchange, and the anionic charges necessary to pair with the cationic functional groups in the crosslinker.

### FIELD

The present disclosure relates to cation exchange polymers, and water-based methods of making such polymers.

### BACKGROUND

The following paragraph is not an admission that anything discussed therein is prior art or part of the knowledge of persons skilled in the art.

Ion-exchange membranes are used in electro-separation technologies, such as electrodialysis (ED), electrodialysis reversal (EDR) and electrodeionization (EDI). The ion-exchange membranes may be used to recover and enrich ions, or remove undesirable/toxic ions from waste water. Cation-exchange membranes may be prepared by polymerizing a monomer having an anionic functional group along with a crosslinker containing at least two polymerizable functionalities. An exemplary anionic functional group is sulfonate. The polymerization may be done in the presence of a stable reinforcing material, such as polypropylene, polyester, polyvinyl chloride, polyethylene, or another reinforcing material known in the art.

Cation-exchange membranes are also used in membrane capacitive deionization. Capacitive deionization (CDI) deionizes water through the electrosorption of ions. Application of an electrical potential difference over two porous carbon electrodes results in removal of anions through storage in the positively polarized electrode, and removal of cations through storage in the negatively polarized electrode. Membrane capacitive deionization includes an anion exchange membrane on the positively polarized electrode and a cation exchange membrane on the negatively polarized electrode.

### INTRODUCTION

The following introduction is intended to introduce the reader to this specification but not to define any invention. One or more inventions may reside in a combination or sub-combination of the elements or method steps described below or in other parts of this document. The inventors do not waive or disclaim their rights to any invention or inventions disclosed in this specification merely by not describing such other invention or inventions in the claims.

Since ionic monomers are charged, they are often water soluble. However, crosslinkers that are currently used for cation-exchange polymers are non-polar organic molecules, and are not sufficiently water soluble that they can be used to generate a homogenous solution with the ionic monomers in water. Without a homogeneous aqueous solution of crosslinkers and ionic monomers, it is difficult to generate a cation-exchange polymer. Mixtures of polar organic solvents or co-solvents may be used to prepare such a sufficiently homogeneous solution. However, using such solvents may be costly, toxic, require one or more downstream processes to treat the waste, or a combination thereof.

It is desirable to develop a method for generating a cation-exchange polymer where the reaction to form the polymer is performed in a water-based solution. One or more described embodiments attempt to address or ameliorate one or more shortcomings involved with producing a cation-exchange resin.

In one aspect, the present disclosure provides a method where an anionic monomer is polymerized in the presence of a crosslinker having a cationic functional group. The cationic crosslinker and the anionic monomer are dissolved in a water-based solution. Since polymerization of an anionic monomer with a cationic crosslinker results in a polymer having cationic functional groups, the authors of the present disclosure determined that the anionic monomer should be used in a sufficient amount to provide both the anionic charges necessary for cation exchange, and the anionic charges necessary to pair with and neutralize the cationic functional groups in the crosslinker. The anionic equivalency (e.g. meq/gram) of the polymer is determined by the molar excess of the anionic charges. The molar excess is determined based on the moles of anionic charges vs. the moles of cationic charges.

The cationic crosslinker and the anionic monomer may be selected so that they are sufficiently soluble in water that a sufficiently homogeneous solution may be made while substantially reducing or avoiding polar organic solvents. A water-soluble polymerization catalyst may be used to help initiate the reaction.

Both the cationic crosslinker and the anionic monomer include mutually polymerizable functional groups. The crosslinker and the monomer may have functional groups that are polymerizable in a free-radical polymerization.

The cationic crosslinker may include a quaternary ammonium functional group, or a pyridinium-based functional group. The anonic monomer may include a sulfonate functional group, a phosphate functional group, or a carboxylate functional group.

As noted above, the method includes polymerizing an anionic monomer in the presence of a cationic crosslinker. In some examples, the method includes first dissolving in the water-based solution the cationic crosslinker and at least one molar equivalent of the anionic monomer, thereby exchanging a non-polymerizable counter-ion for the anionic monomer and forming a cation-based crosslinker paired with a polymerizable counter-ion. Additional anionic monomer is subsequently dissolved in the solution to form the mixture of the anionic monomer and the cationic crosslinker. The resulting mixture is then polymerized. The first portion of anionic monomer may be the same or different from the second portion of anionic monomer. For example, a cation-based crosslinker paired with chloride may be mixed in water with the hydrogen form of the anionic monomer to generate a mixture of chloride ions, hydronium ions, and the cation-based crosslinker paired with the anionic monomer. The resulting solution of the cationic crosslinker paired with the anionic monomer may then be mixed with additional anionic monomer and the resulting mixture polymerized.

In other examples, the method includes dissolving in the water-based solution all of the cationic crosslinker with all of the anionic monomer. This resulting mixture is then polymerized.

Cation-exchange polymers may be made by polymerizing the anionic monomer and the cationic crosslinker in a molar ratio from about 3.0:1 to about 1.8:1 (monomer crosslinker). In monomers and crosslinker that each include only a single change, such ratios result in excess anionic changes of about 2 to about 0.8 moles. The chemical structures of the monomers and crosslinkers, and the amounts of the monomers and crosslinkers, may be selected so that the IEC of the resulting polymer is from about 1 to about 3 meq/g. Such molar ratios may generate a cation-exchange membrane with a desirable ion exchange capacity (IEC), permeability, selectivity, resistance, chemical stability, and mechanical stability. The water content of exemplary polymers may be from about 40% to about 60%. In particular examples, the water content may be from about 45% to about 55%. The resistance of exemplary polymers may be from about 140 Ωcm to about 400 Ωcm. The resistance of some specific polymers disclosed herein may be from about 320 Ωcm to about 400 Ωcm.

The present disclosure also provides a cation-exchange polymer that includes both cationic functional groups and anionic functional groups. The anionic functional groups are present in the polymer in sufficient density, and in sufficient excess of the cationic functional groups, that the polymer has an ion exchange capacity of at least 1.2 meq/g. In some examples, the anionic functional group and the cationic functional group are present in a molar ratio from about 3:1 to 1.8:1, anionic charges to cationic charges. The anionic functional group may be derived from an anionic monomer having a molecular weight of less than 300 per anionic charge.

Without wishing to be bound by theory, the authors of the present disclosure expect that the ion exchange capacity may be increased by: reducing the molecular weight per charge, increasing the molar ratio of anionic charges to cationic charges, or both.

The cation-exchange polymer may be used to coat a carbon electrode, such as a non-faraday carbon electrode for use in an EDR stack. Such a coated carbon electrode may exhibit increased anti-fouling properties and/or increased scaling resistance.

### DETAILED DESCRIPTION

The singular forms “a”, “an”, and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event, or circumstance may or may not occur, or that the subsequently identified material may or may not be present, and that the description includes instances where the event or circumstance occurs or where the material is present, and instances where the event or circumstance does not occur or the material is not present.

In the context of the present disclosure, a “water based solution” would be understood to refer to a reaction solution that is at least 50% water by weight. In some examples, the water-based solution is substantially only water. In some particular examples, the water-based solution is more than 80% water by weight, such as more than 90% water. In some further examples, the water-based solution is more than 95% water by weight. In other particular examples, the water-based solution is more than 99% water by weight. In some examples, the water-based solution does not include any additional solvents. The remaining portion of the water-based solution may be an organic solvent, such as N-methyl-2-pyrrolidone, propylene glycol, dipropylene glycol, 1-propanol, isopropyl alcohol, or any other water-miscible organic solvent. It should be understood that the purity of the water-based solution is determined excluding the reaction materials, such as the crosslinker, monomer, catalyst, and salts associated with any of the reaction materials.

In the context of the present disclosure, it should be understood that discussion of a range of values, such as “at least 50%” or “from 70 to 90”, is intended to include all of the ranges encompassed by the specifically disclosed range. For example, explicit disclosure of the range “at least 50%” is intended to also be a disclosure of the ranges: “50% to 60%”, “70% to 100%”, and “75% to 90%”.

In the context of the present disclosure, “optionally functionalized alkyl” should be understood to encompass a linear or branched C₁₋₂₀ alkyl; and “optionally functionalized aryl” should be understood to encompass a C₅₋₂₀ aryl. An optional functionalization may be the replacement of one or more hydrogen atoms with any combination of: a halide, a heteroatom, an optionally functionalized alkyl, or an optionally functionalized aryl group. In particular examples, the “optionally functionalized alkyl” does not have more than 20 carbon atoms, including the carbon atoms in the optional functional groups. In particular examples, the “optionally functionalized aryl” does not have more than 20 carbon atoms, including the carbon atoms in the optional functional groups. The optional functionalization may be the replacement of one or more carbon atoms with a heteroatom. The optional functionalization may result in the alkyl or aryl group being a heteroalkyl or heteroaryl group. The optional functionalization of an alkyl or aryl group may include replacement of one or more hydrogen atoms, and the replacement of one or more carbon atoms.

An example of an optional functionalization of the alkyl or aryl group is the replacement of a carbon or hydrogen with, or the addition to the compound of, a non-charged functional group that increases the miscibility of the compound in water. An example of such a functionalization includes addition of an oxygen atom to result in: an ether bond, a hydroxyl group, or a heteroaryl compound. Another example of such a functionalization includes the addition of a nitrogen atom to result in a heteroaryl compound. The alkyl or aryl group may be functionalized with a plurality of functional groups. In view of the above, it should be understood that the term “optionally functionalized alkyl” in the context of a linking group includes, for example: —C₆H₁₂—; —C₃H₆(CHOH)C₂H₄—; —C₃H₆—O—C₃H₆—; and cyclic alkyl —C₆H₈(OH)₂—. Similarly, it should be understood that the term “optionally functionalized aryl” in the context of a linking group includes, for example: benzyl; 2-hydroxy benzyl; and 2-methylpyridine, where the two groups being linked are joined to the benzyl, 2-hydroxy benzyl, or 2-methylpyridine in place of hydrogen atoms.

In the context of the present disclosure, it should be understood that “anionic monomer” and “monomer having an anionic group” are equivalent, and both terms refer to both: (i) a monomer having a negative charge and a counter ion, such as 2-Acrylamido-2-methyl-1-propanesulfonate sodium salt, and (ii) a monomer having a neutral charge under one or more preparation conditions but a negative charge in the polymer under cation-exchange conditions, such as 2-Acrylamido-2-methyl-1-propanesulfonic acid.

Generally, the present disclosure provides a method where a molar excess of an anionic monomer is polymerized in the presence of a crosslinker having a cationic functional group to generate a polymer having sufficient anionic charges per gram for cation exchange. The amount of anionic monomer is selected to be sufficient to neutralize the cationic functional groups in the crosslinker, and provide the anionic charges necessary for the polymer to act as a cation-exchange polymer. The anionic equivalency (e.g. meq/gram) of the polymer is determined by the molar excess of the anionic charges. The molar excess is determined based on the moles of anionic charges vs. the moles of cationic charges.

A cationic crosslinker suitable for a method according to the present disclosure includes at least one cationic functional group and at least two polymerizable functional groups. In particular examples, the cationic crosslinker includes only one cationic functional group.

An anionic monomer suitable for a method according to the present disclosure includes at least one anionic functional group and at least one polymerizable functional group.

The polymerizable functional groups are all polymerizable under the same reaction conditions. The polymerizable functional group may be an alkenyl-based functional group, such as a vinyl-based functional group, an acrylate-based functional group, a methacrylate-based functional group, an acrylamide-based functional group, or a methacrylamide-based functional group. It should be understood that, in the context of the present disclosure, functional groups “based on” the noted chemical structures would include bonds to link the functional groups to the rest of the molecules. For example, a methacrylamide-based functional group refers at least to:

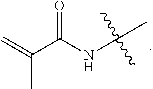 [SMILES: *NC(=O)C(=C)C]

The functional groups “based on” the noted chemical structures may include optional functionalization of the base chemical structure. For example, the term “methacrylamide-based functional group” also refers to compounds of formula:

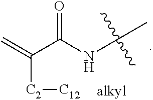

The C₂-C₁₂ alkyl is optionally functionalized.

The cationic and anionic functional groups are joined to their respective polymerizable functional groups by linkers, such as an optionally functionalized alkyl or optionally functionalized aryl group. The linker joining the cationic functional group to one of the polymerizable groups may be different from the linker joining the cationic functional group to the other polymerizable group.

In some examples, the cationic crosslinker has a chemical structure according to Formula (I): P₁—Z₁—N⁺(R₁)(R₂)—Z₂—P₂ where: P₁ and P₂ are each, independently, an alkenyl-based functional group; Z₁ and Z₂ are each, independently, an optionally functionalized alkyl-based linker or an optionally functionalized aryl-based linker; and R₁ and R₂ are each, independently, an optionally functionalized alkyl group, such as methyl.

P₁ and P₂ may be independently, for example: a vinyl-based functional group, an acrylate-based functional group, a methacrylate-based functional group, an acrylamide-based functional group, or a methacrylamide-based functional group. Particular examples of P₁ and P₂ include:

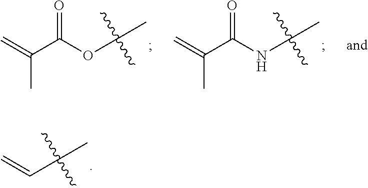

Z₁ and Z₂ may be, for example, independently selected from the group consisting of: optionally functionalized aryl, such as

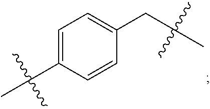 [SMILES: *Cc1ccc(*)cc1]

and C₁₋₂₀ alkyl optionally substituted with hydroxyl, such as ethyl, propyl, or 2-hydroxy propyl.

In specific examples, the cationic crosslinker may be:

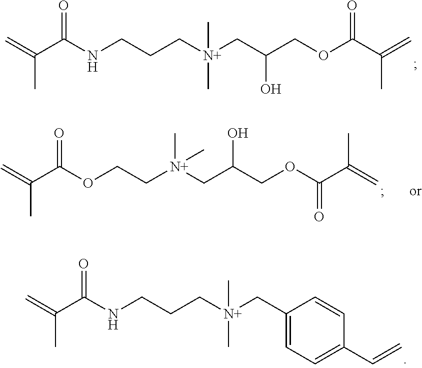

In other examples, the cationic crosslinker may be a compound as disclosed in U.S. Pat. No. 5,118,717 (incorporated herein by reference), such as a compound according to Formula (II):

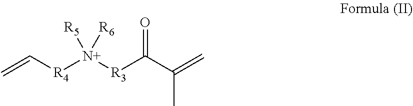

where R₃ is an alkyloxy or an alkylimino group; and R₄ is a benzyl or an alkyl group, and R₅ and R₆ are methyl or higher alkyl group (such as C₂-C₄ alkyl). In specific examples, the cationic crosslinker may be:

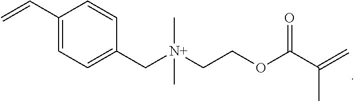 [SMILES: C=Cc1ccc(C[N+](C)(C)CCOC(=O)C(=C)C)cc1]

In yet other examples, the cationic crosslinker be a compound as disclosed in U.S. Pat. No. 7,968,663 (incorporated herein by reference), such as a compound according to Formula (III)

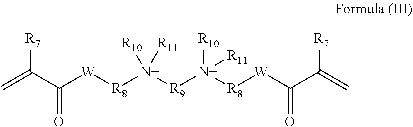

where R₇ is hydrogen or a C₁-C₁₂ alkyl group; R₈ is —[CH₂]ₙ—; R₉ is —[CH₂—CH(OH)]₂—X; R₁₀ and R₁₁ are each, independently, —[CH₂]ₘ—CH₃; W is oxygen or N—R₁₂ where R₁₂ is hydrogen or —[CH₂]r-CH₃; X is a bridging group or atom; m in each instance is an integer from 0 to 20; and n is an integer from 1 to 20. X may be a hydrocarbon group, an inorganic group or inorganic atom. X may be, for example: a C₁-C₃₀ alkyl group, C₁-C₃₀ alkyl ether group, C₆-C₃₀ aromatic group, C₆-C₃₀ aromatic ether group, or a siloxane. X may be, for example: a C₁-C₆ alkyl group, C₁-C₆ alkyl ether group, a C₆-C₁₀ aromatic group, or a C₆-C₁₀ aromatic ether group. X may be, for example: methyl, ethyl, propyl, butyl, isobutyl, phenyl, 1,2-cyclohexanedicarboxylate, bisphenol A, diethylene glycol, resorcinol, cyclohexanedimethanol, poly(dimethylsiloxane), 2,6-tolylene diisocyanate, 1,3-butadiene or dicyclopentadiene.

In specific examples, the cationic crosslinker may be:

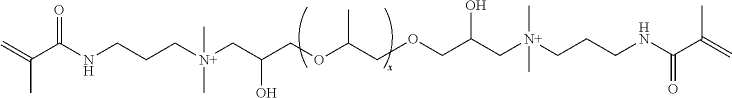

where x is an integer from 0 to 100.

Crosslinkers according to the present disclosure may be prepared by reacting, in water, a polymerizable tertiary amine with a polymerizable alkylating compound to result in a quaternary ammonium compound having two polymerizable functional groups. The polymerizable alkylating compound may include an epoxide and the alkylation may be performed under acidic conditions. The counter-ion of the produced cationic crosslinker may be exchanged though reaction with an anionic monomer. The resulting cationic crosslinker includes a cationic quaternary ammonium group linked to two polymerizable functional groups, and a counter-ion having a polymerizable functional group. The produced crosslinker may be mixed with additional anionic monomer, and a polymerizing initiator. A sufficient amount of anionic monomer may be added to result in a molar ratio from about 3:1 to about 1.8:1 (monomer:crosslinker).

An anionic monomer that may be used in a method according to the present disclosure may have chemical structure according to Formula (IV):

P₃—Z₃-Q Formula (IV)

wherein

P₃ is an alkenyl-based functional group;

Q is —SO₃⁻, —OPO₃⁻, or —COO⁻; and

Z₃ is an optionally functionalized alkyl-based linker, or an optionally functionalized aryl-based linker.

P₃ may be, for example: a vinyl-based functional group, an acrylate-based functional group, a methacrylate-based functional group, an acrylamide-based functional group, or a methacrylamide-based functional group. Particular examples of P₃ include:

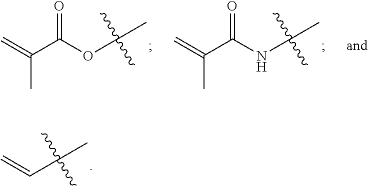

Z₃ may be, for example, aryl or C₁₋₂₀ alkyl. In particular examples, Z₃ is

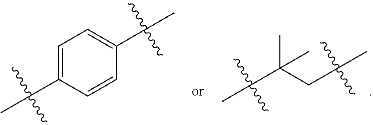

The anionic monomer, absent any counter-ion, may have a molecular weight of less than 300 per anionic charge. Specific examples of an anionic monomer which may be used in a method of the present disclosure include: 2-Acrylamido-2-methyl-1-propanesulfonate (AMPS), 4-vinylbenzenesulfonate, 2-sulfoethylmethacrylate, 3-sulfopropyl acrylate, 3-sulfopropyl methacrylate, and salts thereof.

Polymerizing initiators that may be used in methods according to the present disclosure include water-soluble azo-based initiators, such as 2,2′-Azobis[2-(2-imidazolin-2-yl)propane]dihydrochloride (“VA-044”) and 2,2′-Azobis(2-methylpropionamidine) dihydrochloride (“V-50”).

The mixture of cationic crosslinker, anionic monomer, and initiator may be cast on a backing and cured to initiate polymerization. The backing may be, for example, reinforcing material, such as a fabric, a felt, a microporous support (for example a micro- or ultra-filtration material), or a woven or nonwoven cloth. The backing may be made, for example, of polypropylene, polyester, polyacrylonitrile, polyvinyl chloride or polyamide. The thickness of the resulting membrane may be from about 0.1 mm to about 0.77 mm. The curing may include exposure of the reaction mixture to an elevated temperature, such as about 50° C. to about 120° C., and/or to a UV light. In particular methods, the curing includes increasing the temperature from room temperature to about 120° C. using multiple heating tables.

The non-polymerizable counter-ion of the cationic crosslinker may be the conjugate base of a strong acid, such as an acid having a pKa less than 1. Examples of such non-polymerizable counter-ions include Cl⁻, CH₃—SO₃⁻, NO₃⁻, HSO₄⁻, and citrate.

### Examples—Summary

Specific examples are discussed in greater detail below. Table 1 is a summary of the reagents and amounts used in the discussed examples. GMA=glycidyl methacrylate; DMAPMA=N-[3-(dimethylamino)propyl]methacrylamide; DMAEMA=2-(dimethylamino)ethyl methacrylate; VBC=4-vinylbenzyl chloride; AMPS=2-acrylamido-2-methyl-1-propanesulfonic acid; and SSS=sodium 4-vinylbenzenesulfonate. “AMPS 1” and “SSS 1” refer to the AMPS and SSS compounds used as counter ions to the quaternary ammonium. “AMPS 2” and “SSS 2” refer to the AMPS and SSS compounds used as the source of excess anionic charges. In all of the examples, the total amount of anionic monomer present in a polymerization mixture is the sum of AMPS1 and AMPS2, or of SSS1 and SSS2.

TABLE 1

| | H₂O | GMA | DMAPMA | AMPS 1 | AMPS 2 | VA-044 | Theoretical |
|---|---|---|---|---|---|---|---|
| Example | (g) | (g) | (g) | (g) | (g) | (g) | IEC (meq/g) |
| 1 | 50 | 8.53 | 10.2 | 12.5 | 18.8 | 1 | 1.8 |
| 2 | 20.4 | 4.3 | 5.1 | 6.3 | 7.1 | 1 | 1.5 |
| 3 | 18.2 | 4.3 | 5.1 | 6.3 | 5.3 | 1 | 1.2 |
| | H₂O | GMA | DMAPMA | AMPS 1 | AMPS 2 | V-50 | |
| | (g) | (g) | (g) | (g) | (g) | (g) | |
| 4 | 18.2 | 4.3 | 5.1 | 6.3 | 5.3 | 1 | 1.2 |
| 5 | 18.2 | 4.3 | 5.1 | 6.3 | 5.3 | 1 | 1.2 |
| | H₂O | GMA | DMAEMA | AMPS 1 | AMPS 2 | VA-044 | |
| | (g) | (g) | (g) | (g) | (g) | (g) | |
| 6 | 23.1 | 4.3 | 4.71 | 6.3 | 9.4 | 1 | 1.8 |
| 7 | 20.6 | 4.3 | 4.71 | 6.3 | 6.9 | 1 | 1.5 |
| | H₂O | GMA | DMAPMA | SSS 1 | SSS 2 | V-50 | |
| | (g) | (g) | (g) | (g) | (g) | (g) | |
| 8 | 52.4 | 8.6 | 10.2 | 12.6 | 10.4 | 1 | 1.2 |
| | H₂O | GMA | DMAPMA | SSS 1 | SSS 2 | VA-044 | |
| | (g) | (g) | (g) | (g) | (g) | (g) | |
| 9 | 52.4 | 8.6 | 10.2 | 12.6 | 10.4 | 1 | 1.2 |
| | H₂O | GMA | DMAPMA | SSS 1 | SSS 2 | V-50 | |
| | (g) | (g) | (g) | (g) | (g) | (g) | |
| 10 | 46.7 | 8.6 | 10.2 | 12.6 | 10.4 | 1 | 1.2 |
| | H₂O | GMA | DMAEMA | SSS 1 | SSS 2 | V-50 | |
| | (g) | (g) | (g) | (g) | (g) | (g) | |
| 11 | 57 | 8.4 | 9.3 | 12.2 | 10.4 | 1 | 1.2 |
| | H₂O | VBC | DMAPMA | AMPS 1 | AMPS 2 | VA-044 | |
| | (g) | (g) | (g) | (g) | (g) | (g) | |
| 12 | 45 | 9.3 | 10.4 | 12.6 | 22.8 | 1 | 2 |

### Example 1

Water (50 g) was added to a flask. DMAPMA (10.2 g) was added to the water with stirring. Hydrochloric acid (3.3 g of 33% HCl) was slowly added, maintaining the temperature below 60° C. using a water bath. GMA (8.53 g) was added to the solution and the temperature of the water bath was raised to about 55° C. The reaction was allowed to stir for about 1 hour, resulting in a crosslinker having a quaternary amine group of the following structure:

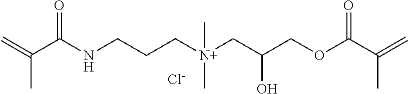 [SMILES: C=C(C)C(=O)NCCC[N+](C)(C)CC(O)COC(=O)C(=C)C ; [Cl-]]

AMPS (12.5 g) was added to the solution, resulting in a crosslinker according to the present disclosure. This AMPS is identified as “AMPS 1” in Table 1. Additional AMPS (18.8 g) was added and allowed to dissolve. This additional AMPS is identified as “AMPS 2” in Table 1.

The resulting mixture was allowed to cool to room temperature. VA-044 (1 g) was added as a polymerizing initiator. The mixture was cast on a backing to result in a membrane having thickness of about 0.6 mm, and cured in an oven at 80-90° C.

The resulting membrane has a water content of about 50% and an IEC of about 1.8 meq/g.

### Example 2

Water (20.4 g) was added to a flask. DMAPMA (5.1 g) was added to the water with stirring. Hydrochloric acid (3.3 g of 33% HCl) was slowly added, maintaining the temperature below 60° C. using a water bath. GMA (4.3 g) was added to the solution and the temperature of the water bath was raised to about 55° C. The reaction was allowed to stir for about 1 hour, resulting in a crosslinker having a quaternary amine group of the following structure:

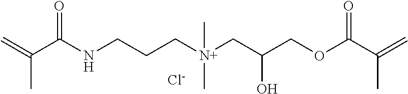 [SMILES: C=C(C)C(=O)NCCC[N+](C)(C)CC(O)COC(=O)C(=C)C ; [Cl-]]

AMPS (6.3 g) was added to the solution, resulting in a crosslinker according to the present disclosure. This AMPS is identified as “AMPS 1” in Table 1. Additional AMPS (7.1 g) was added and allowed to dissolve. This additional AMPS is identified as “AMPS 2” in Table 1.

The resulting mixture was allowed to cool to room temperature. VA-044 (1 g) was added as a polymerizing initiator. The mixture was cast on a backing to result in a membrane having thickness of about 0.6 mm, and cured in an oven at 80-90° C.

The resulting membrane has a water content of about 50% and an IEC of about 1.5 meq/g.

### Example 3

Water (18.2 g) was added to a flask. DMAPMA (5.1 g) was added to the water with stirring. Methanesulfonic acid (2.8 g) was slowly added, maintaining the temperature below 60° C. using a water bath. GMA (4.3 g) was added to the solution and the temperature of the water bath was raised to about 55° C. The reaction was allowed to stir for about 1 hour, resulting in a crosslinker having a quaternary amine group of the following structure:

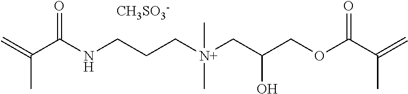

AMPS (6.3 g) was added to the solution, resulting in a crosslinker according to the present disclosure. This AMPS is identified as “AMPS 1” in Table 1. Additional AMPS (5.3 g) was added and allowed to dissolve. This additional AMPS is identified as “AMPS 2” in Table 1.

The resulting mixture was allowed to cool to room temperature. VA-044 (1 g) was added as a polymerizing initiator. The mixture was cast on a backing to result in a membrane having thickness of about 0.6 mm, and cured in an oven at 80-90° C.

The resulting membrane has a water content of about 50% and an IEC of about 1.2 meq/g.

### Example 4

Water (18.2 g) was added to a flask. DMAPMA (5.1 g) was added to the water with stirring. Methanesulfonic acid (2.8 g) was slowly added, maintaining the temperature below 60° C. using a water bath. GMA (4.3 g) was added to the solution and the temperature of the water bath was raised to about 55° C. The reaction was allowed to stir for about 1 hour, resulting in a crosslinker having a quaternary amine group of the following structure:

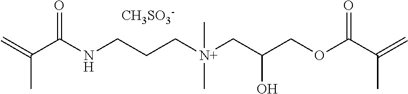

AMPS (6.3 g) was added to the solution, resulting in a crosslinker according to the present disclosure. This AMPS is identified as “AMPS 1” in Table 1. Additional AMPS (5.3 g) was added and allowed to dissolve. This additional AMPS is identified as “AMPS 2” in Table 1. Sodium bicarbonate (4.7 g) was added to convert the AMPS 2 to its sodium form.

The resulting mixture was allowed to cool to room temperature. V-50 (1 g) was added as a polymerizing initiator. The mixture was cast on a backing to result in a membrane having thickness of about 0.6 mm, and cured in an oven at 80-90° C.

The resulting membrane has a water content of about 50% and an IEC of about 1.2 meq/g.

### Example 5

Water (18.2 g) was added to a flask. DMAPMA (5.1 g) was added to the water with stirring. Methanesulfonic acid (2.8 g) was slowly added, maintaining the temperature below 60° C. using a water bath. GMA (4.3 g) was added to the solution and the temperature of the water bath was raised to about 55° C. The reaction was allowed to stir for about 1 hour, resulting in a crosslinker having a quaternary amine group of the following structure:

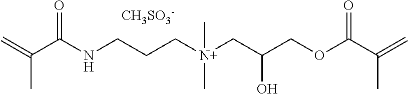

AMPS (6.3 g) was added to the solution, resulting in a crosslinker according to the present disclosure. This AMPS is identified as “AMPS 1” in Table 1. Additional AMPS (5.3 g) was added and allowed to dissolve. This additional AMPS is identified as “AMPS 2” in Table 1. Sodium hydroxide (2.2 g) was added to convert the AMPS 2 to its sodium form.

The resulting mixture was allowed to cool to room temperature. V-50 (1 g) was added as a polymerizing initiator. The mixture was cast on a backing to result in a membrane having thickness of about 0.6 mm, and cured in an oven at 80-90° C.

The resulting membrane has a water content of about 50% and an IEC of about 1.2 meq/g.

### Example 6

Water (23.1 g) was added to a flask. DMAEMA (4.71 g) was added to the water with stirring. Methanesulfonic acid (2.6 g) was slowly added, maintaining the temperature below 60° C. using a water bath. GMA (4.3 g) was added to the solution and the temperature of the water bath was raised to about 55° C. The reaction was allowed to stir for about 1 hour, resulting in a crosslinker having a quaternary amine group of the following structure:

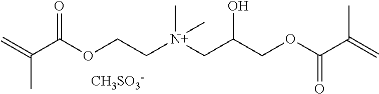

AMPS (6.3 g) was added to the solution, resulting in a crosslinker according to the present disclosure. This AMPS is identified as “AMPS 1” in Table 1. Additional AMPS (9.4 g) was added and allowed to dissolve. This additional AMPS is identified as “AMPS 2” in Table 1.

The resulting mixture was allowed to cool to room temperature. VA-044 (1 g) was added as a polymerizing initiator. The mixture was cast on a backing to result in a membrane having thickness of about 0.6 mm, and cured in an oven at 80-90° C.

The resulting membrane has a water content of about 50% and an IEC of about 1.8 meq/g.

### Example 7

Water (20.6 g) was added to a flask. DMAEMA (4.71 g) was added to the water with stirring. Methanesulfonic acid (2.6 g) was slowly added, maintaining the temperature below 60° C. using a water bath. GMA (4.3 g) was added to the solution and the temperature of the water bath was raised to about 55° C. The reaction was allowed to stir for about 1 hour, resulting in a crosslinker having a quaternary amine group of the following structure:

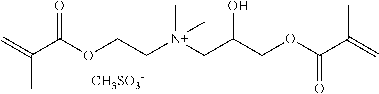

AMPS (6.3 g) was added to the solution, resulting in a crosslinker according to the present disclosure. This AMPS is identified as “AMPS 1” in Table 1. Additional AMPS (6.9 g) was added and allowed to dissolve. This additional AMPS is identified as “AMPS 2” in Table 1.

The resulting mixture was allowed to cool to room temperature. VA-044 (1 g) was added as a polymerizing initiator. The mixture was cast on a backing to result in a membrane having thickness of about 0.6 mm, and cured in an oven at 80-90° C.

The resulting membrane has a water content of about 50% and an IEC of about 1.5 meq/g.

### Example 8

Water (52.4 g) was added to a flask. DMAPMA (8.6 g) was added to the water with stirring. Hydrochloric acid (6.6 g of 33% HCl) was slowly added, maintaining the temperature below 60° C. using a water bath. GMA (8.6 g) was added to the solution and the temperature of the water bath was raised to about 55° C. The reaction was allowed to stir for about 1 hour, resulting in a crosslinker having a quaternary amine group of the following structure:

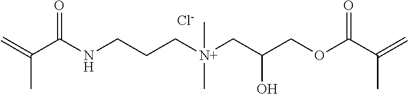 [SMILES: C=C(C)C(=O)NCCC[N+](C)(C)CC(O)COC(=O)C(=C)C ; [Cl-]]

SSS (12.6 g) was added to the solution, resulting in a crosslinker according to the present disclosure. This SSS is identified as “SSS 1” in Table 1. Additional SSS (10.4 g) was added and allowed to dissolve. This additional SSS is identified as “SSS 2” in Table 1.

The resulting mixture was allowed to cool to room temperature. V-50 (1 g) was added as a polymerizing initiator. The mixture was cast on a backing to result in a membrane having thickness of about 0.6 mm, and cured in an oven at 80-90° C.

The resulting membrane has a water content of about 55% and an IEC of about 1.2 meq/g.

### Example 9

Water (52.4 g) was added to a flask. DMAPMA (10.2 g) was added to the water with stirring. Hydrochloric acid (6.6 g of 33% HCl) was slowly added, maintaining the temperature below 60° C. using a water bath. GMA (8.6 g) was added to the solution and the temperature of the water bath was raised to about 55° C. The reaction was allowed to stir for about 1 hour, resulting in a crosslinker having a quaternary amine group of the following structure:

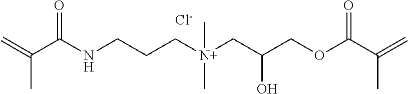 [SMILES: C=C(C)C(=O)NCCC[N+](C)(C)CC(O)COC(=O)C(=C)C ; [Cl-]]

SSS (12.6 g) was added to the solution, resulting in a crosslinker according to the present disclosure. This SSS is identified as “SSS 1” in Table 1. Additional SSS (10.4 g) was added and allowed to dissolve. This additional SSS is identified as “SSS 2” in Table 1.

The resulting mixture was allowed to cool to room temperature. VA-044 (1 g) was added as a polymerizing initiator. The mixture was cast on a backing to result in a membrane having thickness of about 0.6 mm, and cured in an oven at 80-90° C.

The resulting membrane has a water content of about 55% and an IEC of about 1.2 meq/g.

### Example 10

Water (46.7 g) and N-methyl-2-pyrrolidone (NMP) (5.7 g) were added to a flask. DMAPMA (10.2 g) was added to the water and NMP solution with stirring. Hydrochloric acid (6.6 g of 33% HCl) was slowly added, maintaining the temperature below 60° C. using a water bath. GMA (8.6 g) was added to the solution and the temperature of the water bath was raised to about 55° C. The reaction was allowed to stir for about 1 hour, resulting in a crosslinker having a quaternary amine group of the following structure:

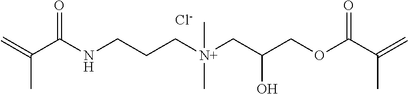 [SMILES: C=C(C)C(=O)NCCC[N+](C)(C)CC(O)COC(=O)C(=C)C ; [Cl-]]

SSS (12.6 g) was added to the solution, resulting in a crosslinker according to the present disclosure. This SSS is identified as “SSS 1” in Table 1. Additional SSS (10.4 g) was added and allowed to dissolve. This additional SSS is identified as “SSS 2” in Table 1.

The resulting mixture was allowed to cool to room temperature. V-50 (1 g) was added as a polymerizing initiator. The mixture was cast on a backing to result in a membrane having thickness of about 0.6 mm, and cured in an oven at 80-90° C.

The resulting membrane has a water content of about 55% and an IEC of about 1.2 meq/g.

The NMP was added to the water to increase the stability of the mixture.

### Example 11

Water (57 g) was added to a flask. DMAEMA (9.3 g) was added to the water with stirring. Methanesulfonic acid (5.6 g) was slowly added, maintaining the temperature below 60° C. using a water bath. GMA (8.4 g) was added to the solution and the temperature of the water bath was raised to about 55° C. The reaction was allowed to stir for about 1 hour, resulting in a crosslinker having a quaternary amine group of the following structure:

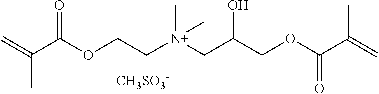

SSS (12.2 g) was added to the solution, resulting in a crosslinker according to the present disclosure. This SSS is identified as “SSS 1” in Table 1. Additional SSS (10.4 g) was added and allowed to dissolve. This additional SSS is identified as “SSS 2” in Table 1.

The resulting mixture was allowed to cool to room temperature. V-50 (1 g) was added as a polymerizing initiator. The mixture was cast on a backing to result in a membrane having thickness of about 0.6 mm, and cured in an oven at 80-90° C.

The resulting membrane has a water content of about 55% and an IEC of about 1.2 meq/g.

### Example 12

Water (45 g) was added to a flask. DMAPMA (10.4 g) was added to the water with stirring. The temperature was raised to 40-42° C., and VBC (9.3 g) was added dropwise to the solution. The temperature of the reaction was maintained below 45° C. The reaction resulted in a crosslinker having a quaternary amine group of the following structure:

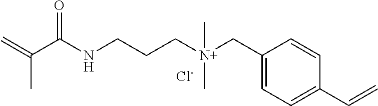 [SMILES: C=Cc1ccc(C[N+](C)(C)CCCNC(=O)C(=C)C)cc1 ; [Cl-]]

The reaction was cooled to room temperature, and AMPS (12.6 g) was added to the solution, resulting in a crosslinker according to the present disclosure. This AMPS is identified as “AMPS 1” in Table 1. Additional AMPS (22.8 g) was added and allowed to dissolve. This additional AMPS is identified as “AMPS 2” in Table 1.

The resulting mixture was allowed to cool to room temperature. VA-044 (1 g) was added as a polymerizing initiator. The mixture was cast on a backing to result in a membrane having thickness of about 0.6 mm, and cured in an oven at 80-90° C.

The resulting membrane has a water content of about 45% and an IEC of about 2 meq/g.

In the preceding description, for purposes of explanation, numerous details are set forth in order to provide a thorough understanding of the examples. However, it will be apparent to one skilled in the art that these specific details are not required. Accordingly, what has been described is merely illustrative of the application of the described examples and numerous modifications and variations are possible in light of the above teachings.

Since the above description provides examples, it will be appreciated that modifications and variations can be effected to the particular examples by those of skill in the art. Accordingly, the scope of the claims should not be limited by the particular examples set forth herein, but should be construed in a manner consistent with the specification as a whole.

1. A method of producing a cation exchange polymer, the method comprising:
polymerizing, in a water-based solution, an anionic monomer in the presence of a crosslinker having a cationic functional group;
wherein the anionic monomer comprises at least one polymerizable functional group, and the cationic crosslinker comprises at least two polymerizable functional groups;
wherein the anionic monomer and the cationic crosslinker are soluble in the water-based solution, and the amounts of anionic monomer and cationic crosslinker are such that there is a molar excess of anionic charges in the polymerized cation exchange polymer.

2. The method according to claim 1, wherein the anionic monomer and the crosslinker are polymerized in a molar ratio such that there are from about 3:1 to about 1.8:1 anionic charges to cationic charges.

3. The crosslinker according to claim 1, wherein the polymerizable functional groups are alkenyl-based functional groups, such as a vinyl-based functional group, an acrylate-based functional group, a methacrylate-based functional group, an acrylamide-based functional group, or a methacrylamide-based functional group.

4. The method according to claim 1, wherein the water-based solution is at least 50% water by weight, such as at least 80% water, at least 90%, at least 95%, or at least 99% water by weight.

5. The method according to claim 1, wherein the cationic crosslinker comprises at least one quaternary ammonium functional group, or at least one pyridinium-based functional group.

6. The method according to claim 5, wherein the cationic crosslinker has a chemical structure according to Formula (I):
P₁—Z₁—N⁺(R₁)(R₂)—Z₂—P₂ Formula (I)
wherein
P₁ and P₂ are each, independently, an alkenyl-based functional group;
Z₁ and Z₂ are each, independently, an alkyl-based or aryl-based linker; and
R₁ and R₂ are each, independently, an alkyl group, and preferably methyl.

7. The method according to claim 6, wherein P₁ and P₂ are independently selected from the group consisting of:

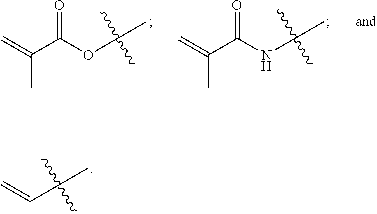

8. The method according to claim 6, wherein Z₁ and Z₂ are independently selected from the group consisting of: optionally functionalized aryl; and C₁₋₂₀ alkyl optionally substituted with hydroxyl.

9. The method according to claim 8, wherein the optionally functionalized aryl is

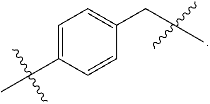 [SMILES: *Cc1ccc(*)cc1]

10. The method according to claim 8, wherein the C₁₋₂₀ alkyl optionally substituted with hydroxyl is: ethyl, propyl, or 2-hydroxy propyl.

11. The method according to claim 1, wherein the cationic crosslinker is:

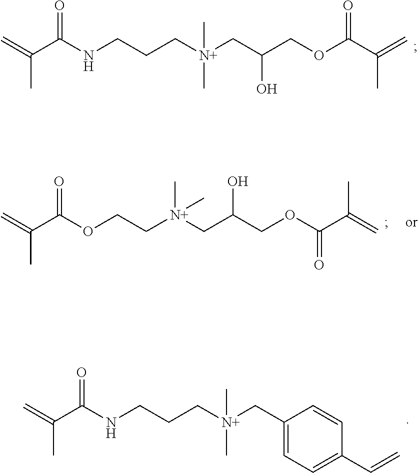

12. The method according to claim 1, wherein the cationic crosslinker has a structure according to Formula (II) or (Ill):

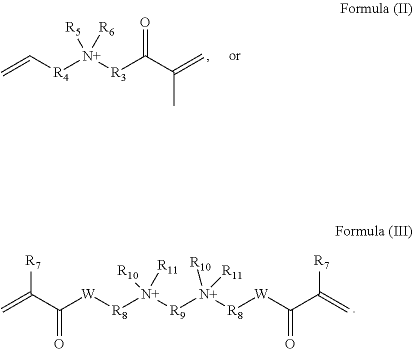

13. The method according to claim 12, wherein the cationic crosslinker has the structure: 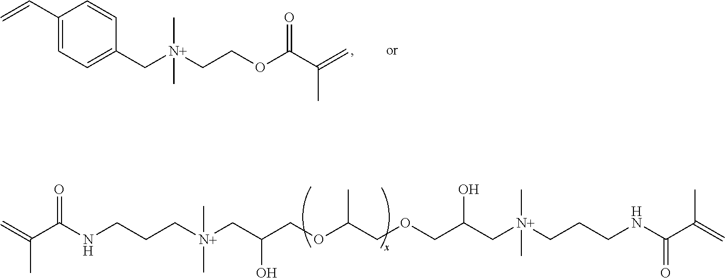
where x is an integer from 0 to 100.

14. The method according to claim 1, wherein the anionic monomer has a chemical structure according to Formula (IV):
P₃—Z₃-Q Formula (IV)
wherein
P₃ is an alkenyl functional group;
Q is —SO₃⁻, —OPO₃⁻, or —COO⁻; and
Z₃ is an optionally functionalized alkyl-based linker, or an optionally functionalized aryl-based linker.

15. The method according to claim 14, wherein Q is —SO₃—.

16. The method according to claim 14, wherein P₃ is selected from the group consisting of:

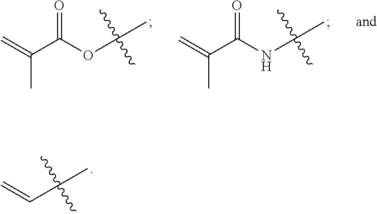

17. The method according to claim 14, wherein Z₃ is aryl or C₁₋₂₀ alkyl.

18. The method according to claim 17, wherein Z₃ is:

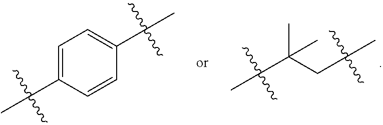

19. The method according to claim 1, wherein the anionic monomer is: 2-acrylamido-2-methyl-1-propanesulfonic acid, 4-vinyl benzenesulfonic acid, 2-sulfoethyl methacrylate, 3-sulfopropyl acrylate, 3-sulfopropyl methacrylate, or a salt thereof.

20. The method according to claim 1, wherein the anionic monomer has a molecular weight of less than 300 per anionic charge.

21. The method according to claim 1, wherein the polymerization is performed on a backing to generate a cation exchange membrane.

22. The method according to claim 1, wherein the polymerization is performed on a carbon electrode, such as to generate a non-faraday carbon electrode for use in an electrodialysis reversal stack.

23. A cation-exchange polymer made according to the method of claim 1.

24. A cation-exchange polymer comprising both cationic functional groups and anionic functional groups, wherein the anionic functional groups are in sufficient excess that the polymer has an ion exchange capacity of at least 1 meq/g.

25. The cation-exchange polymer according to claim 24, wherein the anionic functional group and the cationic functional group are present in a molar ratio from about 3:1 to 1.8:1, anionic charges to cationic charges.

26. The cation-exchange polymer according to claim 24, wherein the anionic functional group is derived from an anionic monomer having a molecular weight of less than 300 per anionic charge.

27. A cation-exchange membrane comprising a backing and the cation-exchange polymer according to claim 23.

28. A carbon electrode coated with the cation-exchange polymer according to claim 23.
